(19) United States
(12) Patent Application Publication
(10) Pub. No.: US 2019/0171188 A1
(43) Pub. Date: Jun. 6, 2019

(54) Biopharmaceutical Batch Recipe Review by Exception

(71) Applicant: Lonza Inc., Morristown, NJ (US)

(72) Inventor: Leslie Fister, Portsmouth, NH (US)

(21) Appl. No.: 16/324,156

(22) PCT Filed: Aug. 10, 2017
(86) PCT No.: PCT/US2017/046292

§ 371 Date: Feb. 8, 2019

Related U.S. Application Data
(60) Provisional application No. 62/372,994, filed on Aug. 10, 2016.

(51) Int. Cl. G05B 19/4155

(52) U.S. Cl. CPC G05B 19/4155; G05B 2219/32097

(57) ABSTRACT

A biopharmaceutical manufacturing control system and associated methods are disclosed herein.

### RELATED APPLICATIONS

This application claims filing benefit of U.S. Provisional Patent Application Ser. No. 62/372,994, filed on Aug. 10, 2016, and which is incorporated herein in its entirety.

### BACKGROUND

The present disclosure relates to manufacturing execution systems, and more specifically, to manufacturing execution systems for biopharmaceutical production.

Cell culture processes are used for cultivating various types of cells, such as mammalian cells. For example, a cell culture process may be implemented, for example, via a bioreactor. It is important in cell culture processes to maintain the proper physicochemical environment for maximum cell cultivation (cells such as Human cells, Chinese Hamster Ovary (CHO) cells, mouse myeloma (NS0), hybridoma), and/or producing the desired product (such as recombinant protein, a monoclonal antibody, antibody fusion protein and other related product types) meeting its quality specifications. For example, factors such as dissolved oxygen levels, culture pH, temperature, shear sensitivity and the like play important roles in the cell culture process. Moreover, the maintenance of the nutritional environment is also important.

However, in the context of producing or cultivating these multiple different cells on a large, industrial scale, maintaining the proper levels of the physicochemical and/or the nutritional environment may be challenging, especially given that a large scale cultivation system may not only require a plurality of bioreactors, but would also require other types of equipment, e.g., preparation equipment, feed equipment, purification equipment, etc., to carry out the various tasks involved in cell cultivation. In this regard, systems and/or methods for maintaining proper environments for cell cultivation in a large scale bioreactor implementation and allowing for operator/user interaction with the implementation are needed.

Manufacturing execution systems are used in biopharmaceutical processing to automate recipe and batch production. These systems and processing steps, however, lack robustness to handle deviations in recipes or process due to a variety of exceptions that occur during production. Therefore, there is a need for improved manufacturing execution systems.

### SUMMARY

Biopharmaceutical manufacturing control systems and associated methods are disclosed herein. In some embodiments, biopharmaceutical manufacturing control systems and associated methods can include a review by exception module, as is further described herein.

### BRIEF DESCRIPTION OF THE DRAWINGS

FIG. 1 illustrates an example system in accordance with one or more aspects of the invention;

FIG. 2 illustrates another example system in accordance with one or more aspects of the invention;

FIG. 3 illustrates an example diagram of system components in accordance with one or more aspects of the invention;

FIG. 4 illustrates another example diagram of system components in accordance with one or more aspects of the invention;

FIG. 5 illustrates an example diagram of an MES;

FIG. 6 illustrates an example diagram of an MES and DCS;

FIG. 7 illustrates an example diagram of an MES with a Review by Exception module; and

FIG. 8 illustrates an example diagram of an MES with a Review by Exception module.

### DETAILED DESCRIPTION

As stated above, the present disclosure relates manufacturing execution systems, which are now described in detail with accompanying figures. It is noted that like reference numerals refer to like elements across different embodiments.

As used herein, the articles “a” and “an” preceding an element or component are intended to be nonrestrictive regarding the number of instances (i.e. occurrences) of the element or component. Therefore, “a” or “an” should be read to include one or at least one, and the singular word form of the element or component also includes the plural unless the number is obviously meant to be singular.

As used herein, the terms “invention” or “present invention” are non-limiting terms and not intended to refer to any single aspect of the particular invention but encompass all possible aspects as described in the specification and the claims.

As used herein, the term “about” modifying the quantity of an ingredient, component, or reactant employed refers to variation in the numerical quantity that can occur, for example, through typical measuring and liquid handling procedures used for making concentrates or solutions. Furthermore, variation can occur from inadvertent error in measuring procedures, differences in the manufacture, source, or purity of the ingredients employed to make the compositions or carry out the methods, and the like. In one aspect, the term “about” means within 10% of the reported numerical value. In another aspect, the term “about” means within 5% of the reported numerical value. Yet, in another aspect, the term “about” means within 10, 9, 8, 7, 6, 5, 4, 3, 2, or 1% of the reported numerical value.

Manufacturing execution systems (“MES”) are control systems for managing and monitoring work-in-process on a factory floor. An MES can keep track of manufacturing information in real time, receiving up-to-the-minute data from robots, machine monitors, and operators. Manufacturing Execution Systems (“MES”), often at least partially implemented in software packages, are used in biopharmaceutical production to control and automate recipe and batch record production. MES systems employed in biopharmaceutical manufacturing, though, suffer from an inability to manage exceptions or deviations from the prescribed recipe or batch that often occur during typical production processes.

MES systems are commercially available. For example, the Syncade™ system is available from Emerson Process Management, 1100 W. Louis Henna Blvd, Round Rock, Tex. 78681. As described in Authoring Comprehensive Recipes, Emerson Process Management, published January 2016, which is hereby incorporated by reference in its entirety, these MES applications can close the gap between enterprise resource planning (“ERP”) systems and production equipment control, distributed control systems (“DCS”), programmable logic controllers (“PLC”), and/or supervisory control and data acquisition (SCADA) applications. MES applications have become essential to support real-time production control, as well as data collection and reporting that are required in order to improve production performance.

In biopharmaceutical manufacturing, MES systems can offer a point of use recipe and batch system that instructs operators how to build particular batches and then the MES catalogues the batch and automates the creation of the batch record. For example, if a buffer is to be produced, the system (through a display) can prompt the operator to obtain an ingredient and scan it in to the MES using barcodes or other tag-in technology such as QR codes, RFID tags, or other inventory management system. The control system would then prompt the operator to obtain the next ingredient and scan that in, and so forth. The improved IVIES described herein builds on this system by including logic and system controls that allow the MES to control an operator or system response when something does not go correctly—i.e., when there is an exception to the process.

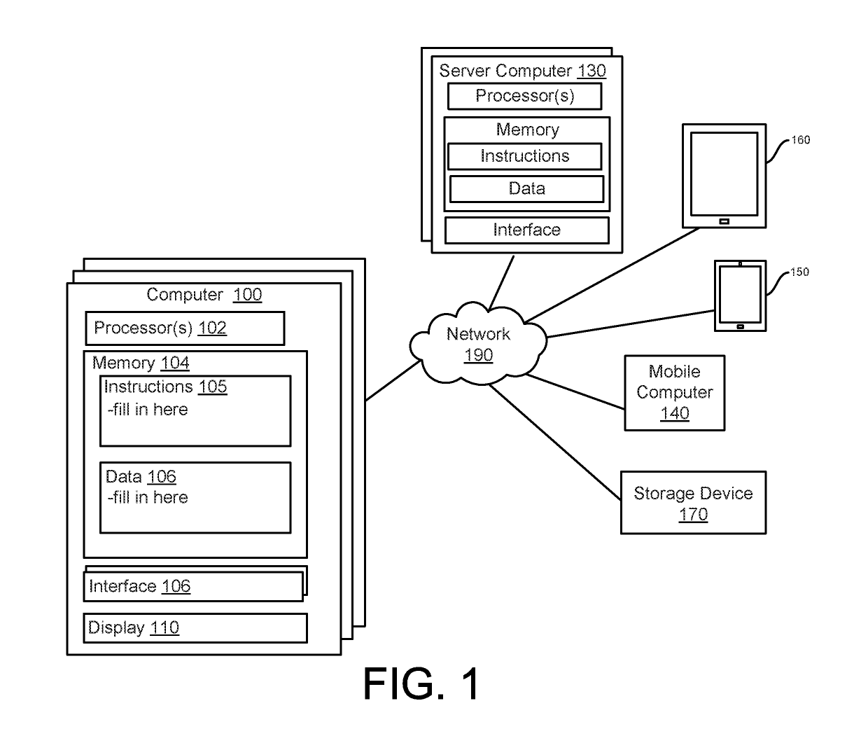

FIG. 1 illustrates an example system in accordance with one or more aspects of the invention. The system may include one or more computing devices, e.g., computer 100, server computer 130, mobile computer 140, smartphone device 150, tablet computer 160, and storage device 170 connected to a network 190. For example, the computer 100 may be a desktop computer, which is intended for use by one or more users. The computer 100 includes various components associated with a desktop computer, such as one or more processors 102, memory 104 (which includes instructions 105 and data 106), one or more interfaces 108, and a display 110. In a further example, similar to the computer 100, the server computer 130 may include at least one processor, memory which also includes instructions and data, one or more interfaces, and/or a display (not shown). Moreover, the mobile computing device 140 may be a laptop (or any type of computer that is mobile, such as an Ultrabook) and also include components similar to the computer 100 and/or server computer 130. The computer 100 may be configured to communicate with the server computer 130, the mobile computer 140, the smartphone device 150, the tablet computer 160 and/or the storage device 170 via the network 190.

As shown in FIG. 1, the cascaded blocks associated with a particular component illustrate that more than one of those components may exist. For example, the two cascaded blocks behind computer 100 represents that there may be two additional computers (in addition to computer 100) connected to network 190. Similarly, the cascaded block behind server computer 130 represents that there may be an additional server computer (in addition to server computer 130) connected to the network 190. The configuration of the cascaded blocks illustrated in FIG. 1 is only an example, and it may be understood that different components can be cascaded and that there may be numerous variations thereof.

The computer 100 may include a processor 102 (e.g., controller, which will be further discussed below), which instructs the various components of computer 100 to perform tasks based on the processing of certain information, such as instructions 105 and/or data 106 stored in the memory 104. For example, the processor 102 may be hardware that can be configured to perform one or more operations, e.g., adding, subtracting, multiplying, comparing, jumping from one program to another program, operating input and output, etc. The processor 102 may be any standard processor, such as a central processing unit (CPU), or may be a dedicated processor, such as an application-specific integrated circuit (ASIC) or a field programmable gate array (FPGA) or an industrial process controller. Moreover, the processor 102 may even be any configuration and/or configuration of circuitry that processes information and/or instructs the components of computer 100. While one processor block is shown in FIG. 1, it may be understood that the computer 100 may also include multiple processors coupled in parallel to individually or collectively perform tasks, as described above.

Memory 104 may be any type of hardware configured to store information accessible by the processor 102, such as instructions 105 and data 106, which can be executed, retrieved, manipulated, and/or stored by the processor 102. It may be physically contained in the computer 100 or coupled to the computer 100. Memory 104 may be ROM, RAM, CD-ROM, hard drive, write-capable, read-only, etc. Moreover, the instructions 105 stored in memory 104 may include any set of instructions that can be executed directly or indirectly by the processor 102. For example, the instructions 105 may be one or more “steps” associated with software that can be executed by the processor 102. The instructions 105 may be also transferred onto memory 104 in various way, e.g., from server computer 130 and/or storage device 170 via network 190. In addition, the data 106 stored in memory 104 may be retrieved, stored or modified by the processor 102, for example, in accordance with the instructions 105. In one aspect, the data 106 may be stored as a collection of data. For instance, although the invention is not limited by any particular data structure, the data 106 may be stored in registers, in a database as a table having multiple fields and records, such as an XML. The data 106 may be formatted in any computer readable format such as, but not limited to, ASCII, Extended Binary-Coded Decimal Interchange Code (EBCDIC), binary, Objectivity, SQL or other database formats, etc. The data 106 may also be any information sufficient to identify the relevant data, such as text, codes, pointers, information used by one or more functions to calculate the data, etc. Similar to the instructions 105, the data 106 may also be transferred onto memory 104 from various components via network 190.

According to one aspect of the invention, the instructions 105 may include at least a set of executable instructions to read various input values from the bioreactors, related equipment, and field devices, exert control, and manage alarms, recording, reporting, communication and alarming functionalities. The instructions 105 may be associated with the various control modules for controlling the field devices and related equipment. The instructions 105 may be executable code or one or more algorithms for processing data. In that regard, and as will be further discussed in the examples below, the set of executable instructions may be considered the “back-bone” of the control module for performing control on one or more bioreactors and related cell cultivation-related equipment, and may be configured to link algorithms, processing conditions, alarms, displays, and other characteristics.

According to another aspect of the invention, the data 106 may include data that may be used by the control module, such as sensor readings, data collected by sensors, predetermined parameters, readings associated with valves, pumps, agitators, scales and switches, user defined target values at which a process value is to be maintained by the IVIES (“setpoint”), temperature measurements, pressure measurements, level measurements, dissolved oxygen measurements, etc.

Interface 108 may be a particular device (such as a field-mounted instrument, processor-to-processor communication, keyboard, mouse, touch sensitive screen, camera, microphone, etc.), a connection or port that allows the reception of information and data, such as interactions from a user or information/data from various components via network 190. For instance, the interface 122 may include one or more input/output ports. The input/output ports may include any type of data port, such as a digital control bus (Foundation™ ProfibusDP™, DeviceNet™, Modbus IEEE RS-485, universal serial bus (USB) drive, zip drive, card reader, CD drive, DVD drive, etc.

The display 110 may be any type of device capable of communicating data to a user. For example, the display 110 may be a liquid-crystal display (LCD) screen, a light emitting diode (LED) screen, a plasma screen, etc. The display 110 may provide to the user various types of information, such as visual representations of the software that can be executed by the computer 100 and various data, and the like, associated therewith.

According to one aspect, a user may input information and/or data using the interface 108. The interface 108 may be a GUI that is displayed to the user/operator on the display 110. By way of example only, the GUI may be the OI that displays processing units and data to a user/operator.

Similar to the computer 100, the server computer 130 may also include one or more processors, memory (which can include instructions and/or data), one or more interfaces, and a display (not shown). The server computer 130 may be rack mounted on a network equipment rack and/or located in a data center. In some examples, via the network 190, the server computer 130 may serve various requests associated with the programs executed on the computer 100, mobile computer 140, the smartphone device 150, the tablet computer 160, and/or the storage device 170. In further examples, the server computer 130 may be part of a plurality of server computers that support a back-end system (which may be “invisible” to users).

Mobile or portable computing devices, such as the mobile computer 140, the smartphone device 150, and tablet computer 160, may include similar components and functions to the computer 100 and/or server computer 130, e.g., one or more processors, memory, input/output capabilities, display, etc. For example, the mobile computer 140 may be any type of device that is mobile or portable with computing capability and connectivity to a network. For example, the mobile computer 140 may be a laptop, an Ultrabook, smartphone, PDA, tablet computer, a wearable computing device, etc. The mobile computer 140 may also have one or more processors, memory, user interfaces, wired or wireless network connection hardware, and other types of components associated with a mobile computing device. Thus, the mobile computer 140 may be able to connect to network 190 via a wired or a wireless connection and communicate with other components connected to the network 190, such as server computer 130, storage device 170, etc.

The smartphone device 150 may be a mobile cellular phone with computing capability and network connectivity. For example, the smartphone 150 may include one or more processors, memory, one or more user interfaces, such as a QWERTY keypad, a camera, image sensors, a global positioning system (GPS), accelerator, temperature sensors, etc. Similar to the computer 100 and the server computer 130, the smartphone device 150 may be configured to execute computer instructions, applications, programs, and any set of instructions and data. Moreover, the tablet computer 160 may also include one or more processors (configured to execute computer instructions and/or applications), memory, one or more interfaces, a touchscreen display, sensors, microphone, camera, speakers, networking hardware (configured to connect to a network, such as network 190, via a wired or wireless connection), etc.

The storage device 170 may be configured to store a large quantity of data and may also be configured to transfer such data when requested or accessed by other components of network 190. For example, the storage device 170 may be a collection of storage components, such as ROM, RAM, hard-drives, solid-state drives, removable drives, network storage, virtual memory, multi-leveled cache, registers, CD, DVD, etc. In addition, the storage device 170 may be configured so other components of network 190, such as the computer 100 and/or server computer 130, can access and provide data to other components connected to the network 190.

By way of example only, the storage device 170 may store the above-described data associated with data 106, such as data that may be used by the control module, such as sensor readings, data collected by sensors, predetermined parameters (e.g., can be downloaded to controllers and referenced by other outside systems and/or users), valve, pump, agitator, scales and switch readings, user defined target values, or 0, at which a process value is to be maintained by the system (such as an MES and/or DCS), temperature measurements, pressure measurements, level measurements, dissolved oxygen measurements, and the like. In another example, the storage device 170 may be updated, for example, to add new data. If the operator, for example, defines a new predetermined value for an alarm function, then the old predetermined value may be updated to reflect the new predetermined value.

The network 190 may be any type of network, wired or wireless, configured to facilitate the transmission of data, instructions, etc. between one or more components of the network. For example, the network 190 may be a local area network (LAN) (e.g., Ethernet or other IEEE 802.03 LAN technologies), Wi-Fi (e.g., IEEE 802.11 standards), wide area network (WAN), virtual private network (VPN), global area network (GAN), or any combinations thereof. In this regard, the computer 100, server computer 130, mobile computer 140, smartphone device 150, and/or tablet computer 160 may connect to and communicate with one another via the network 190.

While the computer 110 may be a desktop computer in the above-described examples, computer 110 is not limited to just desktop computers, and any of the computers illustrated in FIG. 1 may be any device capable of processing instructions and transmitting data, controllers, servers, instruments, Bluetooth devices, wearable computing devices, etc.

Moreover, while processor 102, memory 104, instructions 105, data 106, display 110 are functionally illustrated in FIG. 1 within the same block, it will be understood by those of ordinary skill in the art that those components may actually comprise multiple processors, memories, instructions, data or displays that may or may not be stored within the same physical housing and may optionally include or not include any listed or not-listed components. For example, some or all of the instructions 105 and data 106 may be stored on removable media, or may be stored in a location physically remote from, yet still accessible by, the processor 102. And although the various components of FIG. 1 are connected to the network 190, it may be understood that the components may also be connected to each other, in a multitude of combinations.

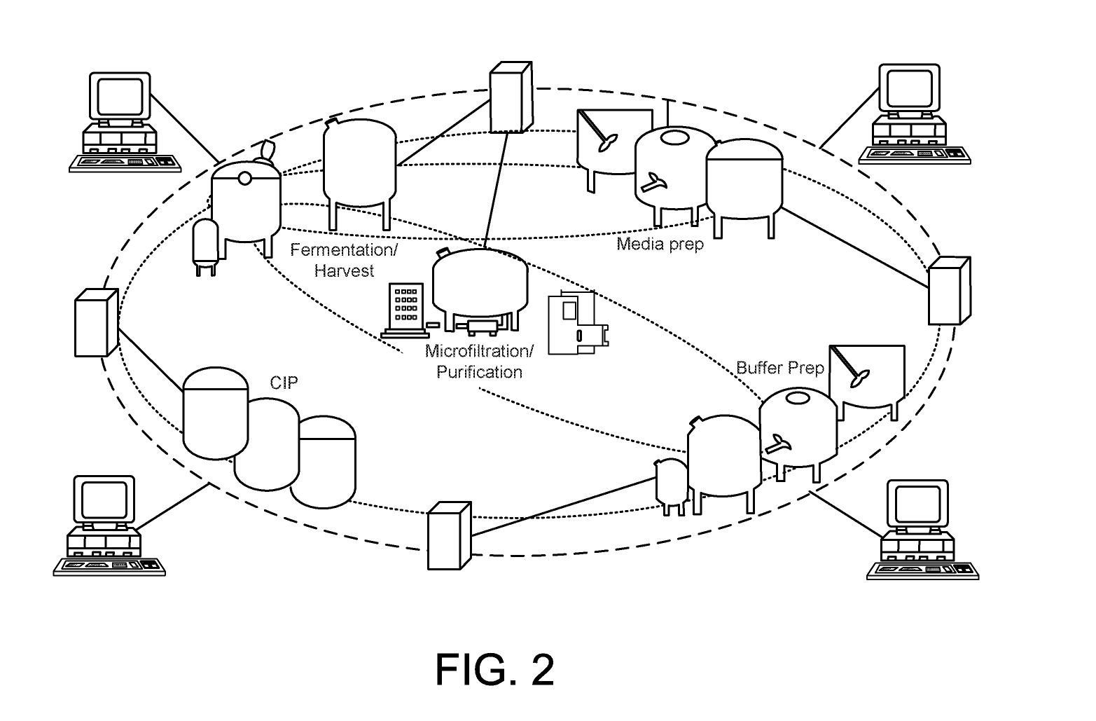

FIG. 2 illustrates another example system in accordance with aspects of the invention. In this example, the system may represent a control system implementing an example MES, and the various components depicted in FIG. 1, may be configured in such a manner to facilitate the control of the bioreactors and related equipment, such as equipment for fermentation and/or harvest, equipment for microfiltration and purification (e.g., chromatography skid), equipment for media preparation, equipment for buffer preparation, and various field devices (e.g., sensors with transmitters, scales, switches, pumps, control valves, discrete valves, pumps with fixed-speed starters or variable frequency drives, agitators with variable frequency drives, discrete valves with limit switches). One or more computers, such as computer 100 of FIG. 1, may be dispersed throughout the system and each computer may be dedicated to certain control and/or portions of the depicted system. Similarly, server computers, such as the server computer 130 of FIG. 1, may also be physical or virtual and dispersed throughout the system and dedicated to certain portions of the system to facilitate the communication of data and instructions.

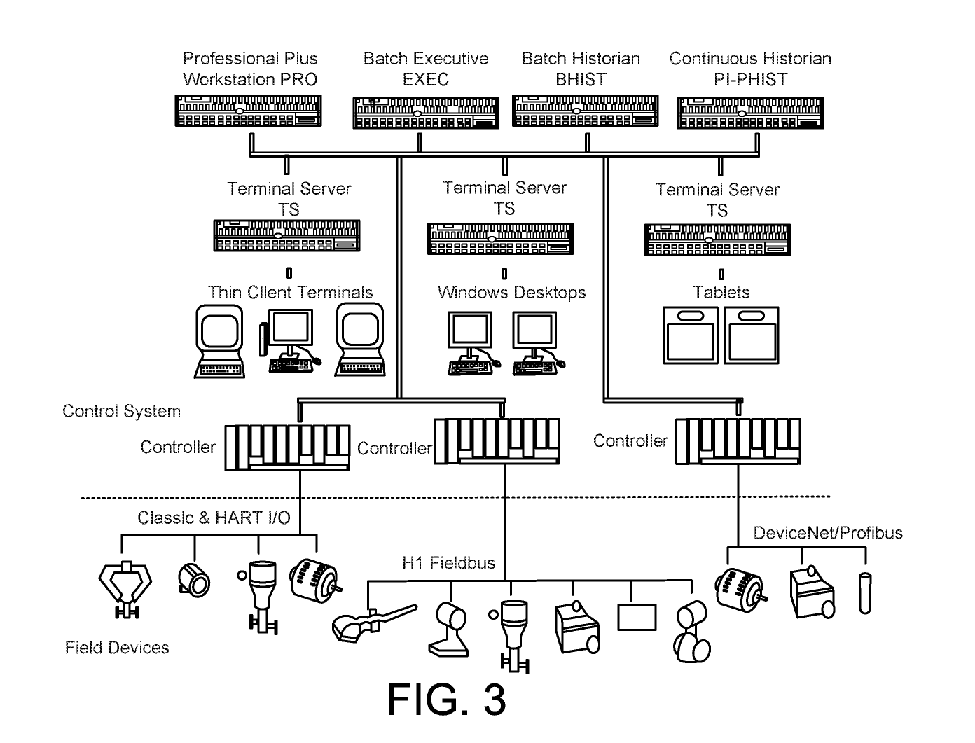

FIG. 3 illustrates an example diagram of the system shown in FIG. 2 in accordance with aspects of the invention, however, it is understood that these aspects can be option in control systems running an MES. As shown in FIG. 2, the Professional Plus Workstation (“PRO”) may be a central database for the control system (which may contain an MES), the Batch Executive (“EXEC”) may store recipe information and may control batch processing, the Batch Historian (“BHIST”) may record and store batch-related data from the control system, the Continuous Historian (“PI-PHIST”) may record and store continuous plant data from the control system, the Terminal Server (“TS”) may be a host for remote access sessions for thin client terminals, such as desktop computers and tablet computers, and the controller is a control system device that may run algorithms and/or set of executable instructions used to control the processing equipment and functionalities and optionally may be configured to control, communicate, or otherwise interface with the MES. Any one of the illustrated components in FIG. 3 may be (or correspond to) one or more of the computer 100, server computer 130, mobile computer 140, smartphone device 150, tablet computer 160, and/or the storage device 170.

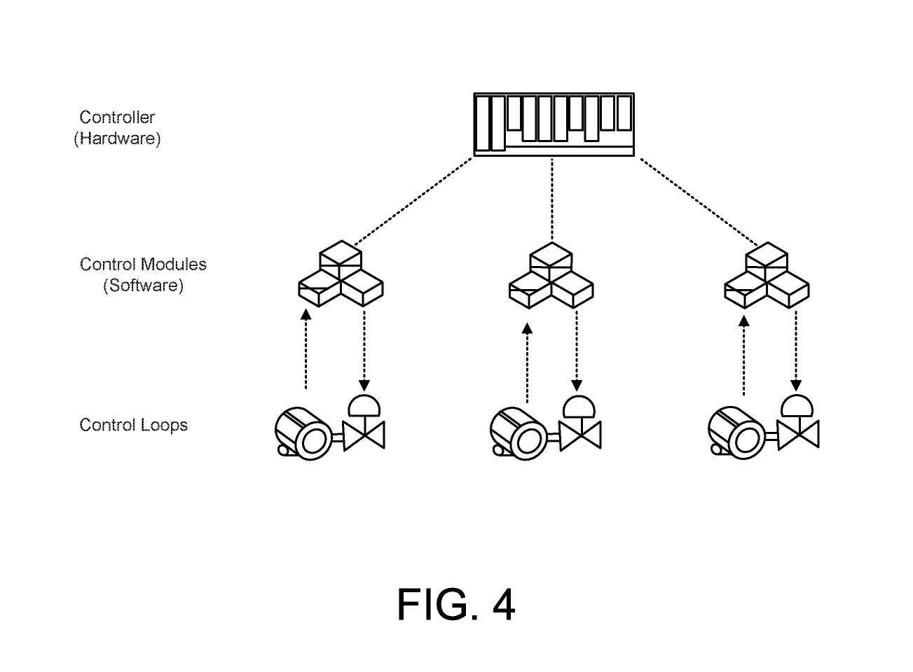

The controller (which may be hardware) implements one or more control modules (which may be software or hardware such as logic gates) to control one or more control loops via the control modules. The control module may be part of the control loop or may be external to the control loop in accordance with aspects of the present invention. This is illustrated by the example diagram in FIG. 4. FIG. 4 shows a controller associated with three different control modules, each of which is associated with three respective control loops. As an example, the algorithms run on the controller may be used in the control loops, batch control and continuous control functionalities, which can optionally be an MES module(s). Moreover, the controller may communicate processing data to system servers, as shown in FIGS. 1 and 3. These controllers, for instance, may also be physically dispersed throughout a particular plant for bioreactor control.

The integration of MES with DCS can be implemented on the systems and devices described in FIGS. 1-4 to increase right-first-time manufacturing by extending electronic procedural control over manual paper-driven processes. When used in combination with traditional batch automation systems, this integration provides comprehensive manufacturing automation from scheduling through product disposition. For example, an MES can provide a recipe to drive manual activities through electronic work instructions, and the DCS recipe can control the instrumented equipment, such as is described above in FIGS. 1-4.

As described in Authoring Comprehensive Recipes, life science, plant floor manufacturing requires both processing steps that are manually performed by operators and automated steps that are performed by a batch control system. Manual processing steps can include, among other things, material charges, filter changes, verifying equipment status, cleaning processes, and many others. Automated processing steps can be involved when the processing can be performed by reading instruments and sequencing values, such as heating phases, agitation, and material transfers.

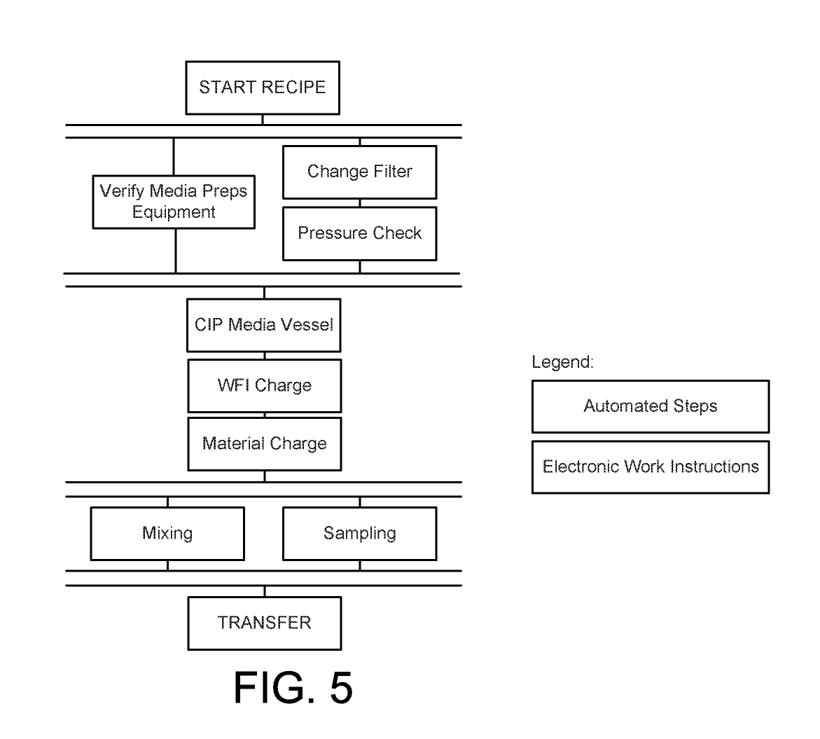

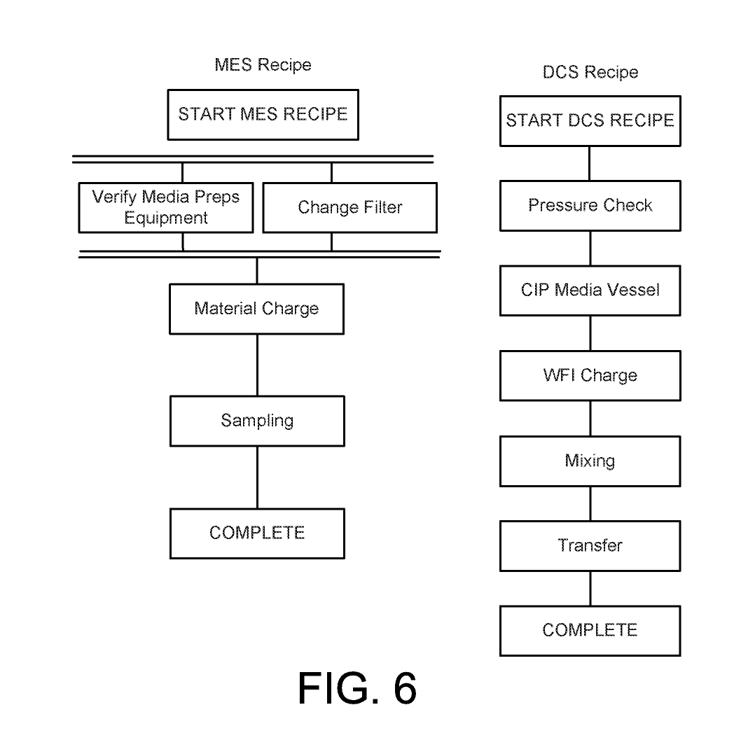

As described, automated processing steps are often performed by actuation or other mechanical device and/or sensors as controlled by the control system(s) described above in relation to FIGS. 1-4. FIG. 5, reproduced from Authoring Comprehensive Recipes, illustrates an example of a simplified media preparation recipe. In FIG. 5, automated steps are shown in dark gray and manual steps are shown in light gray. Execution recipes can require coordination of manual and automated process steps. In plants with only batch automation systems, the manual process steps are often defined in a paper batch record documents and SOPs, with the automated steps executed by a batch control system. In this case, coordination of the manual and automated steps is accomplished by DCS batch prompts, operator radio communication, or SOPs. When an MES system is adopted with electronic batch records as the objective of the system, the manual process steps are executed electronically by the IVIES using electronic work instructions, and there must be coordination of automated steps executed by the DCS and the electronic work instructions executed in the MES. As shown in FIG. 6, also reproduced from Authoring Comprehensive Recipes, the MES and DCS system traditionally have separate systems and recipes configured into each system. Each system will only know about the processing steps run under its domain and the overall context of the complete recipe can be lost.

Moreover, as is described herein, Review by Exception processes can be implemented in the MES (or MES and DCS combination system) to further provide system robustness and increased right-first-time manufacturing. Incorporating Review by Exception processes into an MES can include providing logic pathways that allow for the confirmation that recipe steps were actually completed without exception and, where exceptions occur, providing a recipe step to remedy the exception.

“Review by Exception” as used herein is a design philosophy that includes incorporating process step or steps implemented in a control system that allows for common exceptions to recipes or other process steps to be contemplated and corrected by the control system. As used herein, “exception control module” is a module that employs Review by Exception.

“Exceptions” as used herein means any deviation from a prescribed action. For example, common exceptions include enforcing process sequence, enforcing data entry including proper significant figures, enforcing range or limits, performing calculations, interacting with automation, and enforcing signature requirements.

Improved MES systems that incorporate Review by Exception can be used to control recipe design such that exceptions that are outside the control of automated systems can be accounted and controlled. Exception trees can be constructed by including manufacturing review of each process step and identifying common errors or deviations that occur during the normal course of operation. Additionally, lot review can be utilized to identify exceptions.

For example, if an MES is tasked with providing a recipe and method of making a buffer for downstream processing in a biopharmaceutical production system, the MES would prompt an operator (through a computer such as FIG. 1 instruction 105) to obtain an ingredient container and scan it into the MES, such as by peripheral scanning device configured to scan a barcode, QR code, RFID tag, or other inventory management tag on the ingredient container. The instruction would then check the quality status of the container prior to addition to ensure the material is not expired or blocked. Once checked, subsequent instructions would have the operator add the ingredient to the system and would add the container/lot to the genealogy of the buffer.

Deviations from this process could occur during manufacturing execution. For example, the ingredient container may require replacement prior to addition because the operator observes discoloration, or because the operator damages or spills the container. With a traditional MES that does not implement Review by Exception modules, this deviation would be managed by entering a comment that explains the actions performed. Although the comment may identify the replacement container, the system would not quality check the container prior to use. In addition, the genealogy would reflect the damaged container/lot, and not include the replacement material/lot. This would require manual reconciliation outside of the control of the MES.

In comparison, a traditional MES (and MES and DCS combination) could be enhanced by including logic or modules that allow the system to manage such a deviation. For example, the operator could be prompted to confirm that the scanned container material was added. Once confirmed, the system would add the ingredient to the genealogy of the buffer and proceed. If the container was not added, however, the system could prompt the operator to enter a comment and then scan a replacement container. This replacement container would then be quality checked prior to addition to the system. In addition, the buffer genealogy would reflect the replacement container/lot and not the unused container/lot. As this process manages the deviation, and requires no manual reconciliation, this is herein referred to as a “Review by Exception” process step in the MES recipe and batch production system.

In use, the improved MES builds on the traditional MES (and MES and DCS combination) by including logic or modules that allow the system to control the operator's response when something does not go according to the MES provided recipe or process step, i.e., when there is an exception. For example, the MES can instruct the operator to scan in a particular lot of a first buffer ingredient. The operator then scans it in as the MES asks. Now, rather than asking the operator to scan the next ingredient, the improved MES instructs the operator to add the first buffer ingredient to the system and then confirm that it was added, such as by providing an input to the MES or operating a logic gate to move to the next step. The operator then actually adds the first buffer ingredient to the instructed tank. If he/she does add it, the operator comes back to the MES and confirms it was added and the system moves on to the next step in the recipe. But, sometimes the ingredient is not or cannot be added. For example, if it is discolored, has other quality issues, or is simply spilled on the floor prior to adding. In this instance, the operator would come back to the system and say no, it was not added. The system will then ask for an explanation for the batch record, and then the system will determine how to remedy the problem, for example by having the operator scan a new lot of the first buffer ingredient or perhaps adjust the recipe to accommodate the anomaly. This is herein referred to as a “Review by Exception” process step in the MES recipe and batch production system.

### EXAMPLES

### Example 1

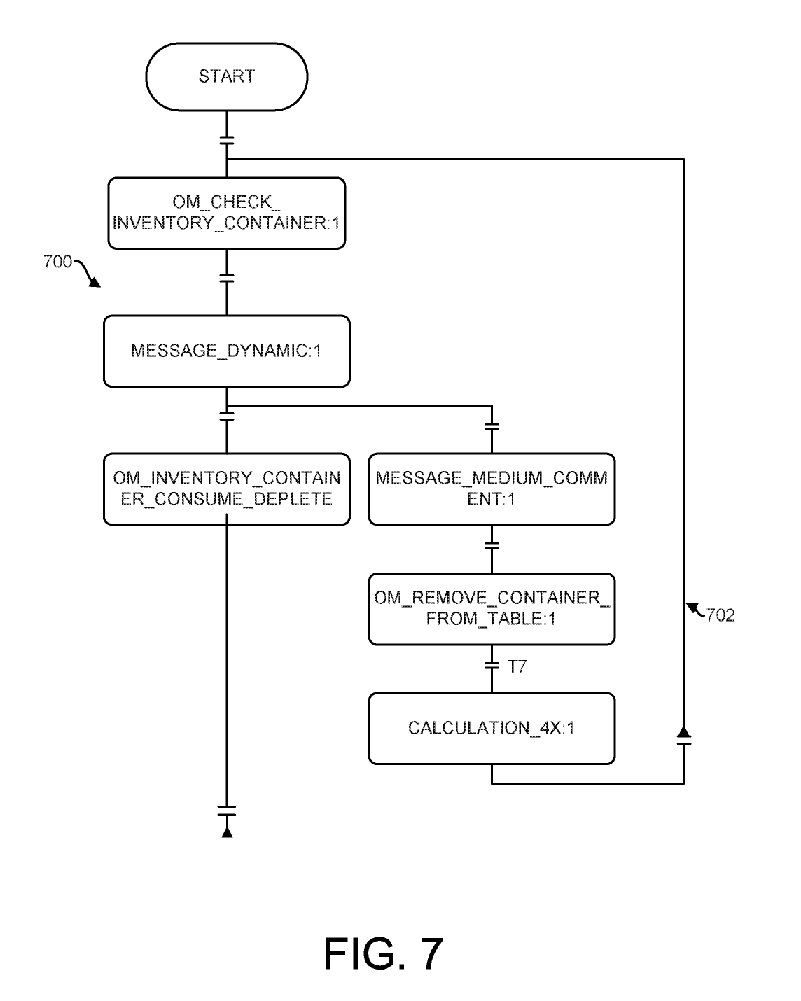

FIG. 7 illustrates an example MES 700 comprising an exception control module (or Review by Exception control module) 702. As shown, the MES contains a traditional MES logic path along the left side of the MES 700. This logic path progress from a start position, to a second position that includes checking an inventory database to determine which lot of a first ingredient should be added pursuant to the recipe selected in the start position of the module. Next, after determining which lot of a first ingredient to add, a message can be displayed to an operator. For example, the message displayed to the operator can instruct the operator of the selected lot chosen from the database and instruct the operator to scan the lot into the control system 700. Next, the MES can include a Review by Exception module 702. The Review by Exception module 702 allows the MES 700 to account for exceptions to the message displayed. As such, the Review by Exception module 702 can include displaying a message to the operator that queries whether the previous message (i.e., instruction to add the lot of the first ingredient) was performed according to the recipe. If no, the module 702 can then remove the lot of the first ingredient from the database and recalculate the appropriate next steps per the recipe. This is then fed back to the traditional MES logic to display a message containing the corrected next recipe step (i.e., a new lot to be scanned could be displayed).

### Example 2

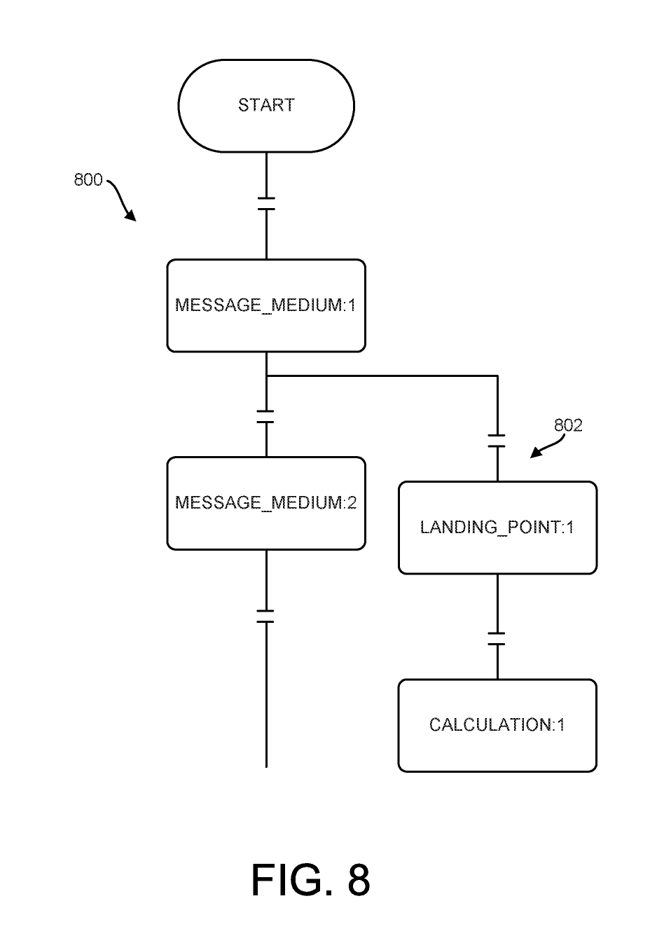

FIG. 8 illustrates an example MES 800 comprising an exception control module (or Review by Exception control module) 802 in an MES system that is configured to control an inventory of available biopharmaceutical processing equipment. For example the MES 800 can be used to inventory available bioreactors in a bioreactor suite such that the MES 800 tracks and identifies which bioreactors are “in-use” or “available.” The MES 800 accounts for exceptions to processes such that tanks and equipment are properly checked in and out as “available” when in reality they were still unavailable. For example, if a clean-in-place process were running on a particular bioreactor, the MES 800 can provide a Review by Exception control module 802 to allow for an operator or control system to account for deviations in the clean-in-place process. For example, if the clean-in-place process experiences an error causing the process to need to be re-started, the module 802 provides a landing point to allow the tank to continue to be checked out as “in-use” while still allowing for the clean-in-place process to be restarted. In essence, the landing point allows the IVIES 800 to have a module to exit out of processes that experience an exception without having to exit out of the MES 800 module entirely. As such, the MES 800 is robust to exceptions in processes that include cataloging the utilization of biopharmaceutical equipment.

Example methods of producing a biopharmaceutical can comprise (a) providing a first recipe step during biopharmaceutical manufacture to an operator and (b) detecting an exception to the first recipe step. The example methods can further include (c) providing corrective action during biopharmaceutical manufacture to obviate the exception against acceptance criteria, (d) confirming that the corrective action was implemented, and (e) producing an automated batch record memorializing the corrective action taken.

Any of the aforementioned steps may be automated steps. For instance, steps (b), (c), and (e) may be automated steps. In addition, step (d) may also be an automated step. Further, step (a) may also be an automated step. Step (c) may be an automated step that is implemented manually by an operator. Step (d) may be determined from operator input.

As an example, the first recipe step may comprise a step of obtaining an ingredient container and scanning the container into a manufacturing execution system. The first recipe step may further comprise checking the quality status of the ingredient container. An exception may be detected such that the corrective action comprises obtaining a replacement ingredient container. Thereafter, the method may further comprise checking the quality status of the replacement ingredient container.

Example manufacturing execution systems can include an exception control module (i.e., a review by exception module).

Example biopharmaceutical manufacturing control systems can comprise a manufacturing execution system implemented configured to receive an input, and an exception control module implemented on the manufacturing execution system that is configured to detect an exception to a process step prescribed by the manufacturing execution system and provide remedial action for the exception. In some aspects, the biopharmaceutical manufacturing control systems can further include a batch executive and a terminal server coupled to a client terminal and configured to communicate with the manufacturing execution system to provide the input.

Example biopharmaceutical manufacturing control systems can include a manufacturing execution system configured to receive an input, and an exception control module implemented on the manufacturing execution system that is configured to detect an exception to a process step prescribed by the manufacturing execution system and provide remedial action for the exception. In some aspects, the biopharmaceutical manufacturing control systems can further include terminal server coupled to a client terminal and configured to provide the input to the manufacturing execution system.

Example biopharmaceutical manufacturing control systems can include a peripheral scanning device, a manufacturing execution system configured to receive an input from the peripheral scanning device, and an exception control module implemented on the manufacturing execution system that is configured to detect an exception to a process step prescribed by the manufacturing execution system and provide remedial action for the exception. Peripheral scanning devices can include any device configured to scan or read a barcode, QR code, RFID tag, or other inventory management tag.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The descriptions of the various embodiments of the present invention can be utilized in the production of pharmaceuticals and biopharmaceutical products. The devices, facilities and methods described herein are suitable for culturing any desired cell line including prokaryotic and/or eukaryotic cell lines. Further, in embodiments, the devices, facilities and methods are suitable for culturing suspension cells or anchorage-dependent (adherent) cells and are suitable for production operations configured for production of pharmaceutical and biopharmaceutical products—such as polypeptide products, nucleic acid products (for example DNA or RNA), or cells and/or viruses such as those used in cellular and/or viral therapies.

In embodiments, the cells express or produce a product, such as a recombinant therapeutic or diagnostic product. As described in more detail below, examples of products produced by cells include, but are not limited to, antibody molecules (e.g., monoclonal antibodies, bispecific antibodies), antibody mimetics (polypeptide molecules that bind specifically to antigens but that are not structurally related to antibodies such as e.g. DARPins, affibodies, adnectins, or IgNARs), fusion proteins (e.g., Fc fusion proteins, chimeric cytokines), other recombinant proteins (e.g., glycosylated proteins, enzymes, hormones), viral therapeutics (e.g., anti-cancer oncolytic viruses, viral vectors for gene therapy and viral immunotherapy), cell therapeutics (e.g., pluripotent stem cells, mesenchymal stem cells and adult stem cells), vaccines or lipid-encapsulated particles (e.g., exosomes, virus-like particles), RNA (such as e.g. siRNA) or DNA (such as e.g. plasmid DNA), antibiotics or amino acids. In embodiments, the devices, facilities and methods can be used for producing biosimilars.

As mentioned, in embodiments, devices, facilities and methods allow for the production of eukaryotic cells, e.g., mammalian cells or lower eukaryotic cells such as for example yeast cells or filamentous fungi cells, or prokaryotic cells such as Gram-positive or Gram-negative cells and/or products of the eukaryotic or prokaryotic cells, e.g., proteins, peptides, antibiotics, amino acids, nucleic acids (such as DNA or RNA), synthesised by the eukaryotic cells in a large-scale manner. Unless stated otherwise herein, the devices, facilities, and methods can include any desired volume or production capacity including but not limited to bench-scale, pilot-scale, and full production scale capacities.

Moreover and unless stated otherwise herein, the devices, facilities, and methods can include any suitable reactor(s) including but not limited to stirred tank, airlift, fiber, microfiber, hollow fiber, ceramic matrix, fluidized bed, fixed bed, and/or spouted bed bioreactors. As used herein, “reactor” can include a fermentor or fermentation unit, or any other reaction vessel and the term “reactor” is used interchangeably with “fermentor.” For example, in some aspects, an example bioreactor unit can perform one or more, or all, of the following: feeding of nutrients and/or carbon sources, injection of suitable gas (e.g., oxygen), inlet and outlet flow of fermentation or cell culture medium, separation of gas and liquid phases, maintenance of temperature, maintenance of oxygen and CO2 levels, maintenance of pH level, agitation (e.g., stirring), and/or cleaning/sterilizing. Example reactor units, such as a fermentation unit, may contain multiple reactors within the unit, for example the unit can have 1, 2, 3, 4, 5, 10, 15, 20, 25, 30, 35, 40, 45, 50, 60, 70, 80, 90, or 100, or more bioreactors in each unit and/or a facility may contain multiple units having a single or multiple reactors within the facility. In various embodiments, the bioreactor can be suitable for batch, semi fed-batch, fed-batch, perfusion, and/or a continuous fermentation processes. Any suitable reactor diameter can be used. In embodiments, the bioreactor can have a volume between about 100 mL and about 50,000 L. Non-limiting examples include a volume of 100 mL, 250 mL, 500 mL, 750 mL, 1 liter, 2 liters, 3 liters, 4 liters, 5 liters, 6 liters, 7 liters, 8 liters, 9 liters, 10 liters, 15 liters, 20 liters, 25 liters, 30 liters, 40 liters, 50 liters, 60 liters, 70 liters, 80 liters, 90 liters, 100 liters, 150 liters, 200 liters, 250 liters, 300 liters, 350 liters, 400 liters, 450 liters, 500 liters, 550 liters, 600 liters, 650 liters, 700 liters, 750 liters, 800 liters, 850 liters, 900 liters, 950 liters, 1000 liters, 1500 liters, 2000 liters, 2500 liters, 3000 liters, 3500 liters, 4000 liters, 4500 liters, 5000 liters, 6000 liters, 7000 liters, 8000 liters, 9000 liters, 10,000 liters, 15,000 liters, 20,000 liters, and/or 50,000 liters. Additionally, suitable reactors can be multi-use, single-use, disposable, or non-disposable and can be formed of any suitable material including metal alloys such as stainless steel (e.g., 316L or any other suitable stainless steel) and Inconel, plastics, and/or glass.

In embodiments and unless stated otherwise herein, the devices, facilities, and methods described herein can also include any suitable unit operation and/or equipment not otherwise mentioned, such as operations and/or equipment for separation, purification, and isolation of such products. Any suitable facility and environment can be used, such as traditional stick-built facilities, modular, mobile and temporary facilities, or any other suitable construction, facility, and/or layout. For example, in some embodiments modular clean-rooms can be used. Additionally and unless otherwise stated, the devices, systems, and methods described herein can be housed and/or performed in a single location or facility or alternatively be housed and/or performed at separate or multiple locations and/or facilities.

By way of non-limiting examples and without limitation, U.S. Publication Nos. 2013/0280797; 2012/0077429; 2011/0280797; 2009/0305626; and U.S. Pat. Nos. 8,298,054; 7,629,167; and 5,656,491, which are hereby incorporated by reference in their entirety, describe example facilities, equipment, and/or systems that may be suitable.

In embodiments, the cells are eukaryotic cells, e.g., mammalian cells. The mammalian cells can be for example human or rodent or bovine cell lines or cell strains. Examples of such cells, cell lines or cell strains are e.g. mouse myeloma (NSO)-cell lines, Chinese hamster ovary (CHO)-cell lines, HT1080, H9, HepG2, MCF7, MDBK Jurkat, NIH3T3, PC12, BHK (baby hamster kidney cell), VERO, SP2/0, YB2/0, Y0, C127, L cell, COS, e.g., COS1 and COS7, QC1-3, HEK-293, VERO, PER.C6, HeLA, EB1, EB2, EB3, oncolytic or hybridoma-cell lines. Preferably the mammalian cells are CHO-cell lines. In one embodiment, the cell is a CHO cell. In one embodiment, the cell is a CHO-K1 cell, a CHO-K1 SV cell, a DG44 CHO cell, a DUXB11 CHO cell, a CHOS, a CHO GS knock-out cell, a CHO FUT8 GS knock-out cell, a CHOZN, or a CHO-derived cell. The CHO GS knock-out cell (e.g., GSKO cell) is, for example, a CHO-K1 SV GS knockout cell. The CHO FUT8 knockout cell is, for example, the Potelligent® CHOK1 SV (Lonza Biologics, Inc.). Eukaryotic cells can also be avian cells, cell lines or cell strains, such as for example, EBx® cells, EB14, EB24, EB26, EB66, or EBv13.

In one embodiment, the eukaryotic cells are stem cells. The stem cells can be, for example, pluripotent stem cells, including embryonic stem cells (ESCs), adult stem cells, induced pluripotent stem cells (iPSCs), tissue specific stem cells (e.g., hematopoietic stem cells) and mesenchymal stem cells (MSCs).

In one embodiment, the cell is a differentiated form of any of the cells described herein. In one embodiment, the cell is a cell derived from any primary cell in culture.

In embodiments, the cell is a hepatocyte such as a human hepatocyte, animal hepatocyte, or a non-parenchymal cell. For example, the cell can be a plateable metabolism qualified human hepatocyte, a plateable induction qualified human hepatocyte, plateable Qualyst Transporter Certified™ human hepatocyte, suspension qualified human hepatocyte (including 10-donor and 20-donor pooled hepatocytes), human hepatic kupffer cells, human hepatic stellate cells, dog hepatocytes (including single and pooled Beagle hepatocytes), mouse hepatocytes (including CD-1 and C57BI/6 hepatocytes), rat hepatocytes (including Sprague-Dawley, Wistar Han, and Wistar hepatocytes), monkey hepatocytes (including Cynomolgus or Rhesus monkey hepatocytes), cat hepatocytes (including Domestic Shorthair hepatocytes), and rabbit hepatocytes (including New Zealand White hepatocytes). Example hepatocytes are commercially available from Triangle Research Labs, LLC, 6 Davis Drive Research Triangle Park, North Carolina, USA 27709.

In one embodiment, the eukaryotic cell is a lower eukaryotic cell such as e.g. a yeast cell (e.g., Pichia genus (e.g. Pichia pastoris, Pichia methanolica, Pichia kluyveri, and Pichia angusta), Komagataella genus (e.g. Komagataella pastoris, Komagataella pseudopastoris or Komagataella phaffii), Saccharomyces genus (e.g. Saccharomyces cerevisae, cerevisiae, Saccharomyces kluyveri, Saccharomyces uvarum), Kluyveromyces genus (e.g. Kluyveromyces lactis, Kluyveromyces marxianus), the Candida genus (e.g. Candida utilis, Candida cacaoi, Candida boidinii), the Geotrichum genus (e.g. Geotrichum fermentans), Hansenula polymorpha, Yarrowia lipolytica, or Schizosaccharomyces pombe. Preferred is the species Pichia pastoris. Examples for Pichia pastoris strains are X33, GS115, KM71, KM71H; and CBS7435.

In one embodiment, the eukaryotic cell is a fungal cell (e.g. Aspergillus (such as A. niger, A. fumigatus, A. orzyae, A. nidula), Acremonium (such as A. thermophilum), Chaetomium (such as C. thermophilum), Chrysosporium (such as C. thermophile), Cordyceps (such as C. militaris), Corynascus, Ctenomyces, Fusarium (such as F. oxysporum), Glomerella (such as G. graminicola), Hypocrea (such as H. jecorina), Magnaporthe (such as M. orzyae), Myceliophthora (such as M. thermophile), Nectria (such as N. heamatococca), Neurospora (such as N. crassa), Penicillium, Sporotrichum (such as S. thermophile), Thielavia (such as T. terrestris, T. heterothallica), Trichoderma (such as T. reesei), or Verticillium (such as V. dahlia)).

In one embodiment, the eukaryotic cell is an insect cell (e.g., Sf9, Mimic™ Sf9, Sf21, High Five (BT1-TN-5B1-4), or BT1-Ea88 cells), an algae cell (e.g., of the genus Amphora, Bacillariophyceae, Dunaliella, Chlorella, Chlamydomonas, Cyanophyta (cyanobacteria), Nannochloropsis, Spirulina, or Ochromonas), or a plant cell (e.g., cells from monocotyledonous plants (e.g., maize, rice, wheat, or Setaria), or from a dicotyledonous plants (e.g., cassava, potato, soybean, tomato, tobacco, alfalfa, Physcomitrella patens or Arabidopsis).

In one embodiment, the cell is a bacterial or prokaryotic cell.

In embodiments, the prokaryotic cell is a Gram-positive cells such as Bacillus, Streptomyces Streptococcus, Staphylococcus or Lactobacillus. Bacillus that can be used is, e.g. the B.subtilis, B.amyloliquefaciens, B.licheniformis, B.natto, or B.megaterium. In embodiments, the cell is B.subtilis, such as B.subtilis 3NA and B.subtilis 168. Bacillus is obtainable from, e.g., the Bacillus Genetic Stock Center, Biological Sciences 556, 484 West 12^{th} Avenue, Columbus Ohio 43210-1214.

In one embodiment, the prokaryotic cell is a Gram-negative cell, such as Salmonella spp. or Escherichia coli, such as e.g., TG1, TG2, W3110, DH1, DHB4, DH5a, HMS 174, HMS174 (DE3), NM533, C600, HB101, JM109, MC4100, XL1-Blue and Origami, as well as those derived from E. coli B-strains, such as for example BL-21 or BL21 (DE3), all of which are commercially available.

Suitable host cells are commercially available, for example, from culture collections such as the DSMZ (Deutsche Sammlung von Mikroorganismen and Zellkulturen GmbH, Braunschweig, Germany) or the American Type Culture Collection (ATCC).

In embodiments, the cultured cells are used to produce proteins e.g., antibodies, e.g., monoclonal antibodies, and/or recombinant proteins, for therapeutic use. In embodiments, the cultured cells produce peptides, amino acids, fatty acids or other useful biochemical intermediates or metabolites. For example, in embodiments, molecules having a molecular weight of about 4000 daltons to greater than about 140,000 daltons can be produced. In embodiments, these molecules can have a range of complexity and can include posttranslational modifications including glycosylation.

In embodiments, the protein is, e.g., BOTOX, Myobloc, Neurobloc, Dysport (or other serotypes of botulinum neurotoxins), alglucosidase alpha, daptomycin, YH-16, choriogonadotropin alpha, filgrastim, cetrorelix, interleukin-2, aldesleukin, teceleulin, denileukin diftitox, interferon alpha-n3 (injection), interferon alpha-n1, DL-8234, interferon, Suntory (gamma-1a), interferon gamma, thymosin alpha 1, tasonermin, DigiFab, ViperaTAb, EchiTAb, CroFab, nesiritide, abatacept, alefacept, Rebif, eptoterminalfa, teriparatide (osteoporosis), calcitonin injectable (bone disease), calcitonin (nasal, osteoporosis), etanercept, hemoglobin glutamer 250 (bovine), drotrecogin alpha, collagenase, carperitide, recombinant human epidermal growth factor (topical gel, wound healing), DWP401, darbepoetin alpha, epoetin omega, epoetin beta, epoetin alpha, desirudin, lepirudin, bivalirudin, nonacog alpha, Mononine, eptacog alpha (activated), recombinant Factor VIII+VWF, Recombinate, recombinant Factor VIII, Factor VIII (recombinant), Alphnmate, octocog alpha, Factor VIII, palifermin, Indikinase, tenecteplase, alteplase, pamiteplase, reteplase, nateplase, monteplase, follitropin alpha, rFSH, hpFSH, micafungin, pegfilgrastim, lenograstim, nartograstim, sermorelin, glucagon, exenatide, pramlintide, iniglucerase, galsulfase, Leucotropin, molgramostirn, triptorelin acetate, histrelin (subcutaneous implant, Hydron), deslorelin, histrelin, nafarelin, leuprolide sustained release depot (ATRIGEL), leuprolide implant (DUROS), goserelin, Eutropin, KP-102 program, somatropin, mecasermin (growth failure), enlfavirtide, Org-33408, insulin glargine, insulin glulisine, insulin (inhaled), insulin lispro, insulin deternir, insulin (buccal, RapidMist), mecasermin rinfabate, anakinra, celmoleukin, 99 mTc-apcitide injection, myelopid, Betaseron, glatiramer acetate, Gepon, sargramostim, oprelvekin, human leukocyte-derived alpha interferons, Bilive, insulin (recombinant), recombinant human insulin, insulin aspart, mecasenin, Roferon-A, interferon-alpha 2, Alfaferone, interferon alfacon-1, interferon alpha, Avonex′ recombinant human luteinizing hormone, dornase alpha, trafermin, ziconotide, taltirelin, diboterminalfa, atosiban, becaplermin, eptifibatide, Zemaira, CTC-111, Shanvac-B, HPV vaccine (quadrivalent), octreotide, lanreotide, ancestirn, agalsidase beta, agalsidase alpha, laronidase, prezatide copper acetate (topical gel), rasburicase, ranibizumab, Actimmune, PEG-Intron, Tricomin, recombinant house dust mite allergy desensitization injection, recombinant human parathyroid hormone (PTH) 1-84 (sc, osteoporosis), epoetin delta, transgenic antithrombin III, Granditropin, Vitrase, recombinant insulin, interferon-alpha (oral lozenge), GEM-21S, vapreotide, idursulfase, omnapatrilat, recombinant serum albumin, certolizumab pegol, glucarpidase, human recombinant C1 esterase inhibitor (angioedema), lanoteplase, recombinant human growth hormone, enfuvirtide (needle-free injection, Biojector 2000), VGV-1, interferon (alpha), lucinactant, aviptadil (inhaled, pulmonary disease), icatibant, ecallantide, omiganan, Aurograb, pexigananacetate, ADI-PEG-20, LDI-200, degarelix, cintredelinbesudotox, Favld, MDX-1379, ISAtx-247, liraglutide, teriparatide (osteoporosis), tifacogin, AA4500, T4N5 liposome lotion, catumaxomab, DWP413, ART-123, Chrysalin, desmoteplase, amediplase, corifollitropinalpha, TH-9507, teduglutide, Diamyd, DWP-412, growth hormone (sustained release injection), recombinant G-CSF, insulin (inhaled, AIR), insulin (inhaled, Technosphere), insulin (inhaled, AERx), RGN-303, DiaPep277, interferon beta (hepatitis C viral infection (HCV)), interferon alpha-n3 (oral), belatacept, transdermal insulin patches, AMG-531, MBP-8298, Xerecept, opebacan, AIDSVAX, GV-1001, LymphoScan, ranpirnase, Lipoxysan, lusupultide, MP52 (beta-tricalciumphosphate carrier, bone regeneration), melanoma vaccine, sipuleucel-T, CTP-37, Insegia, vitespen, human thrombin (frozen, surgical bleeding), thrombin, TransMID, alfimeprase, Puricase, terlipressin (intravenous, hepatorenal syndrome), EUR-1008M, recombinant FGF-I (injectable, vascular disease), BDM-E, rotigaptide, ETC-216, P-113, MBI-594AN, duramycin (inhaled, cystic fibrosis), SCV-07, OPI-45, Endostatin, Angiostatin, ABT-510, Bowman Birk Inhibitor Concentrate, XMP-629, 99 mTc-Hynic-Annexin V, kahalalide F, CTCE-9908, teverelix (extended release), ozarelix, rornidepsin, BAY-504798, interleukin4, PRX-321, Pepscan, iboctadekin, rhlactoferrin, TRU-015, IL-21, ATN-161, cilengitide, Albuferon, Biphasix, IRX-2, omega interferon, PCK-3145, CAP-232, pasireotide, huN901-DMI, ovarian cancer immunotherapeutic vaccine, SB-249553, Oncovax-CL, OncoVax-P, BLP-25, CerVax-16, multi-epitope peptide melanoma vaccine (MART-1, gp100, tyrosinase), nemifitide, rAAT (inhaled), rAAT (dermatological), CGRP (inhaled, asthma), pegsunercept, thymosinbeta4, plitidepsin, GTP-200, ramoplanin, GRASPA, OBI-1, AC-100, salmon calcitonin (oral, eligen), calcitonin (oral, osteoporosis), examorelin, capromorelin, Cardeva, velafermin, 1311-TM-601, KK-220, T-10, ularitide, depelestat, hematide, Chrysalin (topical), rNAPc2, recombinant Factor V111 (PEGylated liposomal), bFGF, PEGylated recombinant staphylokinase variant, V-10153, SonoLysis Prolyse, NeuroVax, CZEN-002, islet cell neogenesis therapy, rGLP-1, BIM-51077, LY-548806, exenatide (controlled release, Medisorb), AVE-0010, GA-GCB, avorelin, ACM-9604, linaclotid eacetate, CETi-1, Hemospan, VAL (injectable), fast-acting insulin (injectable, Viadel), intranasal insulin, insulin (inhaled), insulin (oral, eligen), recombinant methionyl human leptin, pitrakinra subcutancous injection, eczema), pitrakinra (inhaled dry powder, asthma), Multikine, RG-1068, MM-093, NBI-6024, AT-001, PI-0824, Org-39141, Cpn10 (autoimmune diseases/inflammation), talactoferrin (topical), rEV-131 (ophthalmic), rEV-131 (respiratory disease), oral recombinant human insulin (diabetes), RPI-78M, oprelvekin (oral), CYT-99007 CTLA4-Ig, DTY-001, valategrast, interferon alpha-n3 (topical), IRX-3, RDP-58, Tauferon, bile salt stimulated lipase, Merispase, alaline phosphatase, EP-2104R, Melanotan-II, bremelanotide, ATL-104, recombinant human microplasmin, AX-200, SEMAX, ACV-1, Xen-2174, CJC-1008, dynorphin A, SI-6603, LAB GHRH, AER-002, BGC-728, malaria vaccine (virosomes, PeviPRO), ALTU-135, parvovirus B19 vaccine, influenza vaccine (recombinant neuraminidase), malaria/HBV vaccine, anthrax vaccine, Vacc-5q, Vacc-4x, HIV vaccine (oral), HPV vaccine, Tat Toxoid, YSPSL, CHS-13340, PTH(1-34) liposomal cream (Novasome), Ostabolin-C, PTH analog (topical, psoriasis), MBRI-93.02, MTB72F vaccine (tuberculosis), MVA-Ag85A vaccine (tuberculosis), FARA04, BA-210, recombinant plague FIV vaccine, AG-702, OxSODrol, rBetV1, Der-p1/Der-p2/Der-p7 allergen-targeting vaccine (dust mite allergy), PR1 peptide antigen (leukemia), mutant ras vaccine, HPV-16 E7 lipopeptide vaccine, labyrinthin vaccine (adenocarcinoma), CIVIL vaccine, WT1-peptide vaccine (cancer), IDD-5, CDX-110, Pentrys, Norelin, CytoFab, P-9808, VT-111, icrocaptide, telbermin (dermatological, diabetic foot ulcer), rupintrivir, reticulose, rGRF, HA, alpha-galactosidase A, ACE-011, ALTU-140, CGX-1160, angiotensin therapeutic vaccine, D-4F, ETC-642, APP-018, rhMBL, SCV-07 (oral, tuberculosis), DRF-7295, ABT-828, ErbB2-specific immunotoxin (anticancer), DT3SSIL-3, TST-10088, PRO-1762, Combotox, cholecystokinin-B/gastrin-receptor binding peptides, 111In-hEGF, AE-37, trasnizumab-DM1, Antagonist G, IL-12 (recombinant), PM-02734, IMP-321, rhIGF-BP3, BLX-883, CUV-1647 (topical), L-19 based radioimmunotherapeutics (cancer), Re-188-P-2045, AMG-386, DC/1540/KLH vaccine (cancer), VX-001, AVE-9633, AC-9301, NY-ESO-1 vaccine (peptides), NA17.A2 peptides, melanoma vaccine (pulsed antigen therapeutic), prostate cancer vaccine, CBP-501, recombinant human lactoferrin (dry eye), FX-06, AP-214, WAP-8294A (injectable), ACP-HIP, SUN-11031, peptide YY [3-36] (obesity, intranasal), FGLL, atacicept, BR3-Fc, BN-003, BA-058, human parathyroid hormone 1-34 (nasal, osteoporosis), F-18-CCR1, AT-1100 (celiac disease/diabetes), JPD-003, PTH(7-34) liposomal cream (Novasome), duramycin (ophthalmic, dry eye), CAB-2, CTCE-0214, GlycoPEGylated erythropoietin, EPO-Fc, CNTO-528, AMG-114, JR-013, Factor XIII, aminocandin, PN-951, 716155, SUN-E7001, TH-0318, BAY-73-7977, teverelix (immediate release), EP-51216, hGH (controlled release, Biosphere), OGP-I, sifuvirtide, TV4710, ALG-889, Org-41259, rhCC10, F-991, thymopentin (pulmonary diseases), r(m)CRP, hepatoselective insulin, subalin, L19-IL-2 fusion protein, elafin, NMK-150, ALTU-139, EN-122004, rhTPO, thrombopoietin receptor agonist (thrombocytopenic disorders), AL-108, AL-208, nerve growth factor antagonists (pain), SLV-317, CGX-1007, INNO-105, oral teriparatide (eligen), GEM-OS1, AC-162352, PRX-302, LFn-p24 fusion vaccine (Therapore), EP-1043, S pneumoniae pediatric vaccine, malaria vaccine, Neisseria meningitidis Group B vaccine, neonatal group B streptococcal vaccine, anthrax vaccine, HCV vaccine (gpE1+gpE2+MF-59), otitis media therapy, HCV vaccine (core antigen+ISCOMATRIX), hPTH(1-34) (transdermal, ViaDerm), 768974, SYN-101, PGN-0052, aviscumnine, BIM-23190, tuberculosis vaccine, multi-epitope tyrosinase peptide, cancer vaccine, enkastim, APC-8024, GI-5005, ACC-001, TTS-CD3, vascular-targeted TNF (solid tumors), desmopressin (buccal controlled-release), onercept, and TP-9201.

In some embodiments, the polypeptide is adalimumab (HUMIRA), infliximab (REMICADE™), rituximab (RITUXAN™/MAB THERA™) etanercept (ENBREL™) bevacizumab (AVASTIN™), trastuzumab (HERCEPTIN™), pegrilgrastim (NEULASTA™), or any other suitable polypeptide including biosimilars and biobetters.

Other suitable polypeptides are those listed below and in Table 1 of US2016/0097074:

TABLE I

| Protein Product | Reference Listed Drug |
|---|---|
| interferon gamma-1b | Actimmune ® |
| alteplase; tissue plasminogen activator | Activase ®/Cathflo ® |
| Recombinant antihemophilic factor | Advate |
| human albumin | Albutein ® |
| Laronidase | Aldurazyme ® |
| Interferon alfa-N3, human leukocyte | Alferon N ® |
| derived | |
| human antihemophilic factor | Alphanate ® |
| virus-filtered human coagulation factor IX | AlphaNine ® SD |
| Alefacept; recombinant, dimeric fusion | Amevive ® |
| protein LFA3-Ig | |
| Bivalirudin | Angiomax ® |
| darbepoetin alfa | Aranesp ™ |
| Bevacizumab | Avastin ™ |
| interferon beta-1a; recombinant | Avonex ® |
| coagulation factor IX | BeneFix ™ |
| Interferon beta-1b | Betaseron ® |
| Tositumomab | BEXXAR ® |
| antihemophilic factor | Bioclate ™ |
| human growth hormone | BioTropin ™ |
| botulinum toxin type A | BOTOX ® |
| Alemtuzumab | Campath ® |
| acritumomab; technetium-99 labeled | CEA-Scan ® |
| alglucerase; modified form of beta- | Ceredase ® |
| glucocerebrosidase | |
| imiglucerase; recombinant form of beta- | Cerezyme ® |
| glucocerebrosidase | |
| crotalidae polyvalent immune Fab, ovine | CroFab ™ |
| digoxin immune fab [ovine] | DigiFab ™ |
| Rasburicase | Elitek ® |
| Etanercept | ENBREL ® |
| epoietin alfa | Epogen ® |
| Cetuximab | Erbitux ™ |
| algasidase beta | Fabrazyme ® |
| Urofollitropin | Fertinex ™ |
| follitropin beta | Follistim ™ |
| Teriparatide | FORTEO ® |
| human somatropin | GenoTropin ® |
| Glucagon | GlucaGen ® |
| follitropin alfa | Gonal-F ® |
| antihemophilic factor | Helixate ® |
| Antihemophilic Factor; Factor XIII | HEMOFIL |
| adefovir dipivoxil | Hepsera ™ |
| Trastuzumab | Herceptin ® |
| Insulin | Humalog ® |
| antihemophilic factor/von Willebrand | Humate-P ® |
| factor complex-human | |
| Somatotropin | Humatrope ® |
| Adalimumab | HUMIRA ™ |
| human insulin | Humulin ® |
| recombinant human hyaluronidase | Hylenex ™ |
| interferon alfacon-1 | Infergen ® |
| eptifibatide | Integrilin ™ |
| alpha-interferon | Intron A ® |
| Palifermin | Kepivance |
| Anakinra | Kineret ™ |
| antihemophilic factor | Kogenate ® FS |
| insulin glargine | Lantus ® |
| granulocyte macrophage colony- | Leukine ®/ |
| stimulating factor | Leukine ® Liquid |
| lutropin alfa for injection | Luveris |
| OspA lipoprotein | LYMErix ™ |
| Ranibizumab | LUCENTIS ® |
| gemtuzumab ozogamicin | Mylotarg ™ |
| Galsulfase | Naglazyme ™ |
| Nesiritide | Natrecor ® |
| Pegfilgrastim | Neulasta ™ |
| Oprelvekin | Neumega ® |
| Filgrastim | Neupogen ® |
| Fanolesomab | NeutroSpec ™ (formerly |
| | LeuTech ®) |
| somatropin [rDNA] | Norditropin ®/Norditropin |
| | Nordiflex ® |
| Mitoxantrone | Novantrone ® |
| insulin; zinc suspension; | Novolin L ® |
| insulin; isophane suspension | Novolin N ® |
| insulin, regular; | Novolin R ® |
| Insulin | Novolin ® |
| coagulation factor VIIa | NovoSeven ® |
| Somatropin | Nutropin ® |
| immunoglobulin intravenous | Octagam ® |
| PEG-L-asparaginase | Oncaspar ® |
| abatacept, fully human soluable fusion | Orencia ™ |
| protein | |
| muromomab-CD3 | Orthoclone OKT3 ® |
| high-molecular weight hyaluronan | Orthovisc ® |
| human chorionic gonadotropin | Ovidrel ® |
| live attenuated Bacillus Calmette-Guerin | Pacis ® |
| peginterferon alfa-2a | Pegasys ® |
| pegylated version of interferon alfa-2b | PEG-Intron ™ |
| Abarelix (injectable suspension); | Plenaxis ™ |
| gonadotropin-releasing hormone | |
| antagonist | |
| epoietin alfa | Procrit ® |
| Aldesleukin | Proleukin, IL-2 ® |
| Somatrem | Protropin ® |
| dornase alfa | Pulmozyme ® |
| Efalizumab; selective, reversible T-cell | RAPTIVA ™ |
| blocker | |
| combination of ribavirin and alpha interferon | Rebetron ™ |
| Interferon beta 1a | Rebif ® |
| antihemophilic factor | Recombinate ® rAHF/ |
| antihemophilic factor | ReFacto ® |
| Lepirudin | Refludan ® |
| Infliximab | REMICADE ® |
| Abciximab | ReoPro ™ |
| Reteplase | Retavase ™ |
| Rituxima | Rituxan ™ |
| interferon alfa-2^{a} | Roferon-A ® |
| Somatropin | Saizen ® |
| synthetic porcine secretin | SecreFlo ™ |
| Basiliximab | Simulect ® |
| Eculizumab | SOLIRIS (R) |
| Pegvisomant | SOMAVERT ® |
| Palivizumab; recombinantly produced, | Synagis ™ |
| humanized mAb | |
| thyrotropin alfa | Thyrogen ® |
| Tenecteplase | TNKase ™ |
| Natalizumab | TYSABRI ® |
| human immune globulin intravenous 5% and | Venoglobulin-S ® |
| 10% solutions | |
| interferon alfa-n1, lymphoblastoid | Wellferon ® |
| drotrecogin alfa | Xigris ™ |
| Omalizumab; recombinant DNA-derived | Xolair ® |
| humanized monoclonal | |
| antibody targeting immunoglobulin-E | |
| Daclizumab | Zenapax ® |
| ibritumomab tiuxetan | Zevalin ™ |
| Somatotropin | Zorbtive ™ (Serostim ®) |

In embodiments, the polypeptide is a hormone, blood clotting/coagulation factor, cytokine/growth factor, antibody molelcule, fusion protein, protein vaccine, or peptide as shown in Table 2.

TABLE 2
Exemplary Products

| Therapeutic | | |
|---|---|---|
| Product type | Product | Trade Name |
| Hormone | Erythropoietin, Epoein-α | Epogen, Procrit |
| | Darbepoetin-α | Aranesp |
| | Growth hormone (GH), | Genotropin, Humatrope, Norditropin, |
| | somatotropin | NovIVitropin, Nutropin, Omnitrope, |
| | | Protropin, Siazen, Serostim, Valtropin |
| | Human follicle-stimulating | Gonal-F, Follistim |
| | hormone (FSH) | |
| | Human chorionic | Ovidrel |
| | gonadotropin | Luveris |
| | Lutropin-α | GlcaGen |
| | Glucagon | Geref |
| | Growth hormone releasing | ChiRhoStim (human peptide), SecreFlo |
| | hormone (GHRH) | (porcine peptide) |
| | Secretin | Thyrogen |
| | Thyroid stimulating | |
| | hormone (TSH), | |
| | thyrotropin | |
| Blood | Factor VIIa | NovoSeven |
| Clotting/Coagulation | Factor VIII | Bioclate, Helixate, Kogenate, |
| Factors | | Recombinate, ReFacto |
| | Factor IX | |
| | Antithrombin III (AT-III) | Benefix |
| | Protein C concentrate | Thrombate III |
| | | Ceprotin |
| Cytokine/Growth | Type I alpha-interferon | Infergen |
| factor | Interferon-αn3 (IFNαn3) | Alferon N |
| | Interferon-β1a (rIFN- β) | Avonex, Rebif |
| | Interferon-β1b (rIFN- β) | Betaseron |
| | Interferon-γ1b (IFN γ) | Actimmune |
| | | Proleukin |
| | Aldesleukin (interleukin | |
| | 2(IL2), epidermal | |
| | theymocyte activating | Kepivance |
| | factor; ETAF | Regranex |
| | Palifermin (keratinocyte | |
| | growth factor; KGF) | Anril, Kineret |
| | Becaplemin (platelet- | |
| | derived growth factor; | |
| | PDGF) | |
| | Anakinra (recombinant IL1 | |
| | antagonist) | |
| Antibody molecules | Bevacizumab (VEGFA | Avastin |
| | mAb) | Erbitux |
| | Cetuximab (EGFR mAb) | Vectibix |
| | Panitumumab (EGFR | Campath |
| | mAb) | Rituxan |
| | Alemtuzumab (CD52 | Herceptin |
| | mAb) | Orencia |
| | Rituximab (CD20 chimeric | Humira |
| | Ab) | Enbrel |
| | Trastuzumab (HER2/Neu | |
| | mAb) | Remicade |
| | Abatacept (CTLA Ab/Fc | Amevive |
| | fusion) | Raptiva |
| | Adalimumab (TNFα mAb) | Tysabri |
| | Etanercept (TNF | Soliris |
| | receptor/Fc fusion) | Orthoclone, OKT3 |
| | Infliximab (TNFα | |
| | chimeric mAb) | |
| | Alefacept (CD2 fusion | |
| | protein) | |
| | Efalizumab (CD11a mAb) | |
| | Natalizumab (integrin α4 | |
| | subunit mAb) | |
| | Eculizumab (C5mAb) | |
| | Muromonab-CD3 | |
| Other: | Insulin | Humulin, Novolin |
| Fusion | Hepatitis B surface antigen | Engerix, Recombivax HB |
| proteins/Protein | (HBsAg) | |
| vaccines/Peptides | HPV vaccine | Gardasil |
| | OspA | LYMErix |
| | Anti-Rhesus(Rh) | Rhophylac |
| | immunoglobulin G | Fuzeon |
| | Enfuvirtide | |
| | Spider silk, e.g., fibrion | QMONOS |

In embodiments, the protein is multispecific protein, e.g., a bispecific antibody as shown in Table 3.

TABLE 3
Bispecific Formats

| Name (other | | | | | |
|---|---|---|---|---|---|
| names, | | | Proposed | | Diseases (or |
| sponsoring | BsAb | | mechanisms of | Development | healthy |
| organizations) | format | Targets | action | stages | volunteers) |
| Catumaxomab | BsIgG: | CD3, | Retargeting of T | Approved in | Malignant |
| (Removab ®, | Triomab | EpCAM | cells to tumor, Fc | EU | ascites in |
| Fresenius | | | mediated | | EpCAM positive |
| Biotech, Trion | | | effector | | tumors |
| Pharma, | | | functions | | |
| Neopharm) | | | | | |
| Ertumaxomab | BsIgG: | CD3, HER2 | Retargeting of T | Phase I/II | Advanced solid |
| (Neovii Biotech, | Triomab | | cells to tumor | | tumors |
| Fresenius | | | | | |
| Biotech) | | | | | |
| Blinatumomab | BiTE | CD3, CD19 | Retargeting of T | Approved in | Precursor B-cell |
| (Blincyto ®, AMG | | | cells to tumor | USA | ALL |
| 103, MT 103, | | | | Phase II and | ALL |
| MEDI 538, | | | | III | DLBCL |
| Amgen) | | | | Phase II | NHL |
| | | | | Phase I | |
| REGN1979 | BsAb | CD3, CD20 | | | |
| (Regeneron) | | | | | |
| Solitomab (AMG | BiTE | CD3, | Retargeting of T | Phase I | Solid tumors |
| 110, MT110, | | EpCAM | cells to tumor | | |
| Amgen) | | | | | |
| MEDI 565 (AMG | BiTE | CD3, CEA | Retargeting of T | Phase I | Gastrointestinal |
| 211, MedImmune, | | | cells to tumor | | adenocancinoma |
| Amgen) | | | | | |
| RO6958688 | BsAb | CD3, CEA | | | |
| (Roche) | | | | | |
| BAY2010112 | BiTE | CD3, PSMA | Retargeting of T | Phase I | Prostate cancer |
| (AMG 212, | | | cells to tumor | | |
| Bayer; Amgen) | | | | | |
| MGD006 | DART | CD3, CD123 | Retargeting of T | Phase I | AML |
| (Macrogenics) | | | cells to tumor | | |
| MGD007 | DART | CD3, gpA33 | Retargeting of T | Phase I | Colorectal |
| (Macrogenics) | | | cells to tumor | | cancer |
| MGD011 | DART | CD19, CD3 | | | |
| (Macrogenics) | | | | | |
| SCORPION | BsAb | CD3, CD19 | Retargeting of T | | |
| (Emergent | | | cells to tumor | | |
| Biosolutions, | | | | | |
| Trubion) | | | | | |
| AFM11 (Affimed | TandAb | CD3, CD19 | Retargeting of T | Phase I | NHL and ALL |
| Therapeutics) | | | cells to tumor | | |
| AFM12 (Affimed | TandAb | CD19, CD16 | Retargeting of | | |
| Therapeutics) | | | NK cells to | | |
| | | | tumor cells | | |
| AFM13 (Affimed | TandAb | CD30, | Retargeting of | Phase II | Hodgkin's |
| Therapeutics) | | CD16A | NK cells to | | Lymphoma |
| | | | tumor cells | | |
| GD2 (Barbara | T cells | CD3, GD2 | Retargeting of T | Phase I/II | Neuroblastoma |
| Ann Karmanos | preloaded | | cells to tumor | | and |
| Cancer Institute) | with BsAb | | | | osteosarcoma |
| pGD2 (Barbara | T cells | CD3, Her2 | Retargeting of T | Phase II | Metastatic breast |
| Ann Karmanos | preloaded | | cells to tumor | | cancer |
| Cancer Institute) | with BsAb | | | | |
| EGFRBi-armed | T cells | CD3, EGFR | Autologous | Phase I | Lung and other |
| autologous | preloaded | | activated T cells | | solid tumors |
| activated T cells | with BsAb | | to EGFR- | | |
| (Roger Williams | | | positive tumor | | |
| Medical Center) | | | | | |
| Anti-EGFR- | T cells | CD3, EGFR | Autologous | Phase I | Colon and |
| armed activated | preloaded | | activated T cells | | pancreatic |
| T-cells (Barbara | with BsAb | | to EGFR- | | cancers |
| Ann Karmanos | | | positive tumor | | |
| Cancer Institute) | | | | | |
| rM28 (University | Tandem | CD28, | Retargeting of T | Phase II | Metastatic |
| Hospital | scFv | MAPG | cells to tumor | | melanoma |
| Tübingen) | | | | | |
| IMCgp100 | ImmTAC | CD3, peptide | Retargeting of T | Phase I/II | Metastatic |
| (Immunocore) | | MHC | cells to tumor | | melanoma |
| DT2219ARL | 2 scFv | CD19, CD22 | Targeting of | Phase I | B cell leukemia |
| (NCI, University | linked to | | protein toxin to | | or lymphoma |
| of Minnesota) | diphtheria | | tumor | | |
| | toxin | | | | |
| XmAb5871 | BsAb | CD19, | | | |
| (Xencor) | | CD32b | | | |
| NI-1701 | BsAb | CD47, CD19 | | | |
| (NovImmune) | | | | | |
| MM-111 | BsAb | ErbB2, | | | |
| (Merrimack) | | ErbB3 | | | |
| MM-141 | BsAb | IGF-1R, | | | |
| (Merrimack) | | ErbB3 | | | |
| NA (Merus) | BsAb | HER2, | | | |
| | | HER3 | | | |
| NA (Merus) | BsAb | CD3, | | | |
| | | CLEC12A | | | |
| NA (Merus) | BsAb | EGFR, | | | |
| | | HER3 | | | |
| NA (Merus) | BsAb | PD1, | | | |
| | | undisclosed | | | |
| NA (Merus) | BsAb | CD3, | | | |
| | | undisclosed | | | |
| Duligotuzumab | DAF | EGFR, | Blockade of 2 | Phase I and II | Head and neck |
| (MEHD7945A, | | HER3 | receptors, | Phase II | cancer |
| Genentech, | | | ADCC | | Colorectal |
| Roche) | | | | | cancer |
| LY3164530 (Eli | Not | EGFR, MET | Blockade of 2 | Phase I | Advanced or |
| Lily) | disclosed | | receptors | | metastatic |
| | | | | | cancer |
| MM-111 | HSA body | HER2, | Blockade of 2 | Phase II | Gastric and |
| (Merrimack | | HER3 | receptors | Phase I | esophageal |
| Pharmaceuticals) | | | | | cancers |
| | | | | | Breast cancer |
| MM-141, | IgG-scFv | IGF-1R, | Blockade of 2 | Phase I | Advanced solid |
| (Merrimack | | HER3 | receptors | | tumors |
| Pharmaceuticals) | | | | | |
| RG7221 | CrossMab | Ang2, VEGF | Blockade of 2 | Phase I | Solid tumors |
| (RO5520985, | | A | proangiogenics | | |
| Roche) | | | | | |
| RG7716 (Roche) | CrossMab | Ang2, VEGF | Blockade of 2 | Phase I | Wet AMD |
| | | A | proangiogenics | | |
| OMP-305B83 | BsAb | DLL4/VEGF | | | |
| (OncoMed) | | | | | |
| TF2 | Dock and | CEA, HSG | Pretargeting | Phase II | Colorectal, |
| (Immunomedics) | lock | | tumor for PET or | | breast and lung |
| | | | radioimaging | | cancers |
| ABT-981 | DVD-Ig | IL-1α, IL-1β | Blockade of 2 | Phase II | Osteoarthritis |
| (AbbVie) | | | proinflammatory | | |
| | | | cytokines | | |
| ABT-122 | DVD-Ig | TNF, IL- | Blockade of 2 | Phase II | Rheumatoid |
| (AbbVie) | | 17A | proinflammatory | | arthritis |
| | | | cytokines | | |
| COVA322 | IgG- | TNF, IL17A | Blockade of 2 | Phase I/II | Plaque psoriasis |
| | fynomer | | proinflammatory | | |
| | | | cytokines | | |
| SAR156597 | Tetravalent | IL-13, IL-4 | Blockade of 2 | Phase I | Idiopathic |
| (Sanofi) | bispecific | | proinflammatory | | pulmonary |
| | tandem | | cytokines | | fibrosis |
| | IgG | | | | |
| GSK2434735 | Dual- | IL-13, IL-4 | Blockade of 2 | Phase I | (Healthy |
| (GSK) | targeting | | proinflammatory | | volunteers) |
| | domain | | cytokines | | |
| Ozoralizumab | Nanobody | TNF, HSA | Blockade of | Phase II | Rheumatoid |
| (ATN103, | | | proinflammatory | | arthritis |
| Ablynx) | | | cytokine, binds | | |
| | | | to HSA to | | |
| | | | increase half-life | | |
| ALX-0761 | Nanobody | IL-17A/F, | Blockade of 2 | Phase I | (Healthy |
| (Merck Serono, | | HSA | proinflammatory | | volunteers) |
| Ablynx) | | | cytokines, binds | | |
| | | | to HSA to | | |
| | | | increase half-life | | |
| ALX-0061 | Nanobody | IL-6R, HSA | Blockade of | Phase I/II | Rheumatoid |
| (AbbVie, Ablynx; | | | proinflammatory | | arthritis |
| | | | cytokine, binds | | |
| | | | to HSA to | | |
| | | | increase half-life | | |
| ALX-0141 | Nanobody | RANKL, | Blockade of | Phase I | Postmenopausal |
| (Ablynx, | | HSA | bone resorption, | | bone loss |
| Eddingpharm) | | | binds to HSA to | | |
| | | | increase half-life | | |
| RG6013/ACE910 | ART-Ig | Factor IXa, | Plasma | Phase II | Hemophilia |
| (Chugai, Roche) | | factor X | coagulation | | |

What is claimed is:

1. A method of producing a biopharmaceutical, comprising:
a) providing a first recipe step during biopharmaceutical manufacture to an operator;
b) detecting an exception to the first recipe step;
c) providing corrective action during biopharmaceutical manufacture to obviate the exception against acceptance criteria;
d) confirming that the corrective action was implemented; and
e) producing an automated batch record memorializing the corrective action taken.

2. The method of claim 1, wherein steps b), c), and e) are automated steps.

3. The method of claim 2, wherein steps b)-e) are automated steps.

4. The method of claim 3, wherein steps a)-e) are automated steps.

5. The method of claim 1, wherein step c) is an automated step that is implemented manually by an operator.

6. The method of claim 1, wherein step d) is determined from operator input.

7. The method of claim 1, wherein the first recipe step comprises a step of obtaining an ingredient container and scanning the container into a manufacturing execution system.

8. The method of claim 7, wherein the first recipe step further comprises checking the quality status of the ingredient container.

9. The method of claim 8, wherein an exception is detected and the corrective action comprises obtaining a replacement ingredient container.

10. The method of claim 9, wherein the method further comprises checking the quality status of the replacement ingredient container.

11. A biopharmaceutical manufacturing control system, comprising:
a manufacturing execution system; and
an exception control module implemented on the manufacturing execution system that is configured to detect an exception to a process step prescribed by the manufacturing execution system and provide remedial action for the exception.

12. The system of claim 11, wherein the manufacturing execution system is implemented by a batch executive and configured to receive an input.

13. The system of claim 11, wherein the system further comprises a client terminal.

14. The system of claim 13, wherein the manufacturing execution system is configured to receive an input from the client terminal.

15. The system of claim 11, wherein the system further comprises a peripheral scanning device.

16. The system of claim 15, wherein the manufacturing execution system is configured to receive an input from the peripheral scanning device.

17. A manufacturing execution system, comprising: an exception control module.

18. The system of claim 17, wherein the system comprises at least one client terminal, at least one server computer, and at least one controller.
